(19) United States
(12) Patent Application Publication
(10) Pub. No.: US 2009/0147110 A1
(43) Pub. Date: Jun. 11, 2009

(54) Video Processing Device

(75) Inventors: Hirokazu Muramatsu, Shizuoka (JP); Keiji Toyoda, Shizuoka (JP); Kenji Tamura, Kanagawa (JP)

Correspondence Address: PEARNE & GORDON LLP, 1801 EAST 9TH STREET, SUITE 1200, CLEVELAND, OH, 44114-3108, US

(73) Assignee: PANASONIC CORPORATION, Kadoma-Shi, Osaka (JP)

(21) Appl. No.: 11/719,374

(22) PCT Filed: Nov. 16, 2005
(86) PCT No.: PCT/JP2005/021050

§ 371 Date: May 15, 2007

(30) Foreign Application Priority Data
Nov. 16, 2004 (JP) 2004-331829

(51) Int. Cl. H04N 5/20

(52) U.S. Cl. 348/255; 348/E05.073

(57) ABSTRACT

It is an object of the present invention to provide a video processing apparatus which can perform separately two shading corrections including a dark shading correction of an image and a peripheral shading correction for light falloff at edges of the image, and can calculate, with accuracy, correction gains corresponding to respective pixels from the correction values of blocks. The video processing apparatus comprises an imaging element 2 for producing an image of an object, a correction value storage unit 5c having stored therein correction values of blocks each of which forms part of the image produced by the imaging element 2, a correction gain interpolating unit 5d for calculating a correction gain of a designated pixel of the imaging element 2 by performing an interpolation on the basis of correction values corresponding to blocks which are in the vicinity of the designated pixel, a dark shading correction unit for performing a dark shading correction of the image on the basis of the correction gain calculated by the correction gain interpolating unit 5d, and a peripheral shading correction unit 5f for performing a peripheral shading correction for light falloff at edges of the image on the basis of the correction gain calculated by the correction gain interpolating unit 5d.

### TECHNICAL FIELD OF THE INVENTION

The present invention relates to a video processing apparatus for performing a shading correction of an image signal.

### DESCRIPTION OF THE RELATED ART

As a technology for shading correction, there has been known a video processing apparatus which is shown in FIGS. 14 and 15. An image taken by an imaging element is divided into blocks Bk, while correction values Pc corresponding to the blocks Bk is read out from a correction value storage unit 211g. A correction value producing unit 211a produces correction values of pixels by processing the correction values Pc of blocks Bk with weight on the basis of positions of pixels. A correction unit 211e performs a correction for light falloff at edges on the basis of the produced correction values (see, for example, patent document 1).

The conventional video processing apparatus is adapted to calculate correction gains of pixels from correction data Pc of block Bk on amount of light on the basis of four-point linear interpolation method of performing, as shown in FIG. 16, an interpolation by using four block F1 to F4 including a block Bk having a relevant pixel Px, and blocks Bk adjacent to the relevant pixel Px, and adjacent to each other.

patent document 1: Jpn. unexamined patent publication No. 2001-275029 (pages 11-14 and FIGS. 5, 9, and 10)

### DISCLOSURE OF THE INVENTION

### Problems to be Solved by the Invention

The conventional video processing apparatus is adapted to perform the correction for light falloff at edges. However, the conventional video processing apparatus is not adapted to perform the correction for dark shading depending on characteristics of an imaging element.

The conventional video processing apparatus, however, encounters such a problem that the image tends to be deteriorated by boundary lines of blocks under the condition that the image is divided into relatively large blocks, resulting from the fact that the four-point linear interpolation method is inferior in accuracy. On the other hand, the amount of correction values of blocks is increased under the condition that the image is divided into relatively small blocks.

It is, therefore, an object of the present invention to provide a video processing apparatus which can perform separately two shading corrections including a dark shading correction of an image and a peripheral shading correction for light falloff at edges of the image, and can calculate, with accuracy, correction gains corresponding to respective pixels from the correction values of blocks through first and second interpolations without being increased in circuit size.

### Means for Solving the Problems

The video processing apparatus according to the present invention, comprises: an imaging element for producing an image of an object; a correction value storage unit having stored therein correction values of blocks each of which forms part of the image produced by the imaging element; a correction gain interpolating unit for calculating a correction gain of a designated pixel of the imaging element by performing an interpolation on the basis of correction values corresponding to blocks which are in the vicinity of the designated pixel; a dark shading correction unit for performing a dark shading correction of the image on the basis of the correction gain calculated by the correction gain interpolating unit; and a peripheral shading correction unit for performing a peripheral shading correction for light falloff at edges of the image on the basis of the correction gain calculated by the correction gain interpolating unit.

The video processing apparatus thus constructed as previously mentioned can reduce the amount of correction values by reason that the correction gain interpolating unit is adapted to calculate a correction gain of each pixel from the collection values of blocks by performing an interpolation on the basis of correction values of blocks, and perform separately two shading corrections by comprising two correction units for dark shading of image and light falloff at edges of image.

In the video processing apparatus according to the present invention, the correction gain interpolating means may have a first correction gain calculating function of calculating a first correction gain by performing four-point linear interpolation on the basis of four correction values including a correction value corresponding to a block including the designated pixel, and correction values corresponding to blocks which are in the vicinity of the block including the designated pixel, and a second correction gain calculating function of calculating a second correction gain by performing a second interpolation on the basis of the first correction gain.

The video processing apparatus thus constructed as previously mentioned can calculate, with accuracy, correction gains of pixels from the correction values of blocks in comparison with the conventional video processing apparatus without being affected by boundary lines between blocks by reason that the interpolated correction values are firstly calculated from the correction values of blocks through the four-point linear interpolation in the first stage, the correction gains of pixels are then calculated from the interpolated correction values through the second interpolation in the second stage.

In the video processing apparatus according to the present invention, the correction values of blocks stored in the correction value storage unit may include correction values for the dark shading correction and correction values for the peripheral shading correction.

The video processing apparatus thus constructed as previously mentioned can have correction values of blocks corresponding to each shadings by reason that the correction values of blocks for the dark shading correction and the correction values of blocks for the peripheral shading correction are separately stored in the correction value storage unit.

In the video processing apparatus according to the present invention, the correction values of blocks stored in the correction value storage unit may include correction values for the dark shading correction, and corresponding to the blocks of the image, and correction values for the peripheral shading correction.

The video processing apparatus thus constructed as previously mentioned can be improved in construction by reason that the correction gain interpolating unit is adapted to perform the interpolations on the basis of the correction values of blocks for the dark shading correction, and the interpolations on the basis of the correction values of blocks for the peripheral shading correction, the dark sharing and peripheral sharing correction units are adapted to share the correction gain interpolating unit.

In the video processing apparatus according to the present invention, the imaging element may have a plurality of color filters regularly arranged in a specific order, and corresponding to the respective pixels.

The video processing apparatus thus constructed as previously mentioned can perform the correction on the basis of the type of the color filter of each pixel by reason that the imaging element has a plurality of color filters regularly arranged in a specific order, and corresponding to the respective pixels.

In the video processing apparatus according to the present invention, the correction value storage unit may have correction values corresponding to primary colors of the color filters, and corresponding to the blocks.

The video processing apparatus thus constructed as previously mentioned can perform the correction on the basis of the correction values corresponding to primary colors of the color filters by reason that the correction value storage unit has correction values corresponding to primary colors of the color filters, and corresponding to the blocks.

In the video processing apparatus according to the present invention, the correction gain interpolating unit may be adapted to calculate a correction gain on the basis of the correction values corresponding to primary colors of the color filters.

The video processing apparatus thus constructed as previously mentioned can perform the interpolation on the basis of the correction values corresponding to primary colors of the color filters by reason that the correction gain interpolating unit is adapted to calculate a correction gain on the basis of the correction values corresponding to primary colors of the color filters.

In the video processing apparatus according to the present invention, the dark shading and peripheral shading correction units may be adapted to perform a color shading correction of the image on the basis of the correction values corresponding to primary colors of the color filters.

The video processing apparatus thus constructed as previously mentioned can perform the color shading correction on the basis of the correction values corresponding to primary colors of the color filters.

In the video processing apparatus according to the present invention, the correction value storage unit may have communication means for receiving latest correction values corresponding to the blocks from an external apparatus, and updating the previous correction values of blocks with the latest correction values of blocks.

The video processing apparatus thus constructed as previously mentioned can update the correction values of blocks if necessary, and perform, with accuracy, the shading corrections on the basis of the updated correction values by reason that the correction value storage unit has communication means for receiving latest correction values corresponding to the blocks from an external apparatus, and updating the previous correction values of blocks with the latest correction values of blocks.

In the video processing apparatus according to the present invention, the correction gain interpolating unit may be adapted to adjust in size the blocks on the basis of the size of the image to calculate correction values corresponding to the adjusted blocks, and to calculate a correction gain on the basis of correction values corresponding to the blocks adjusted in size.

The video processing apparatus thus constructed as previously mentioned can perform, with accuracy, the corrections without being affected by the size of the image produced by the imaging element, and without updating the correction values of blocks on the basis of the size of the image produced by the imaging element.

In the video processing apparatus according to the present invention, the correction gain interpolating unit may be adapted to calculate a correction gain by performing an interpolation on the basis of an interpolation method corresponding to arbitrarily defined blocks.

The video processing apparatus thus constructed as previously mentioned can selectively use the interpolation methods in each block.

In the video processing apparatus according to the present invention, the correction gain interpolating unit may be adapted to calculate a correction value of a block which is not stored in the correction value storage unit, on the basis of the correction values of blocks adjacent to the block corresponding to which is not stored in the correction value storage unit.

The video processing apparatus thus constructed as previously mentioned can reduce the amount of correction values stored in the correction value storage unit and the amount of the latest correction values to be received from the external apparatus.

In the video processing apparatus according to the present invention, the correction gain interpolating unit may be adapted to calculate a correction gain by performing an interpolation on the basis of the pixel skipping of the imaging element.

The video processing apparatus thus constructed as previously mentioned can reduce the amount of correction values stored in the correction value storage unit, without being affected by the pixel skipping of the imaging element, by performing an interpolation on the basis of the pixel skipping of the imaging element.

In the video processing apparatus according to the present invention, the correction gain interpolating unit may be adapted to adjust coordinates of each pixel of the imaging element by performing a displacement correction on the basis of a displacement of the imaging element to an optical axis, and to calculate an interpolated correction value from the correction values stored in the correction value storage unit by performing the interpolation on the basis of the adjusted coordinates of each pixel of the imaging element.

The video processing apparatus thus constructed as previously mentioned can calculate, with accuracy, a correction gain of a designated pixel, without having stored therein correction values for a displacement of the imaging element to an optical axis, by adjusting coordinates of each pixel of the imaging element on the basis of a displacement of the imaging element to an optical axis.

### Advantageous Effect of the Invention

The present invention provides a video processing apparatus that can perform separately two shading corrections by comprising two correction units for dark shading of image and light falloff at edges of image, calculate, with accuracy, a correction gain of a designated pixel from correction values of blocks by performing two stage interpolations, and perform two or more shading corrections without being increased in circuit size.

### BRIEF DESCRIPTION OF THE DRAWINGS

FIG. 1 is a block diagram showing an embodiment of the video processing apparatus according to the present invention.

FIG. 2 is a diagram for explaining a process in which signals of pixels are outputted in a specific order from the imaging element of the video processing apparatus according to the embodiment of the present invention.

FIG. 3 is a diagram for explaining an image divided into a plurality of blocks in the embodiment of the video processing apparatus according to the present invention.

FIG. 4 is a diagram for explaining a process in which the video processing apparatus according to the embodiment of the present invention selects correction values from among the correction values corresponding to the respective blocks of the image.

FIG. 5 is a diagram for explaining the first interpolation to be performed on the basis of the selected correction values by the video processing apparatus according to the embodiment of the present invention.

FIG. 6 is a diagram for explaining that the four-point linear interpolation cannot be performed in a peripheral portion of an image by the video processing apparatus according to the embodiment of the present invention.

FIG. 7 is a diagram for explaining a first interpolation to be performed in a peripheral portion of an image by the video processing apparatus according to the embodiment of the present invention.

FIG. 8 is a diagram for explaining a four-point linear interpolation to be used in various fields.

FIG. 9 is a diagram for explaining a four-point linear interpolation to be performed on the basis of the difference value by the video processing apparatus according to the embodiment of the present invention.

FIG. 10 is a diagram for explaining the second stage of the interpolation method in the embodiment of the video processing apparatus according to the present invention.

FIG. 11 is a diagram for explaining that the second interpolation cannot be performed by the video processing apparatus according to the embodiment of the present invention.

FIG. 12 is a block diagram for explaining the shading corrections to be performed on the basis of the correction gain.

FIG. 13 is a diagram for explaining a displacement of the imaging element to an optical axis.

FIG. 14 is a block diagram showing a conventional video processing apparatus.

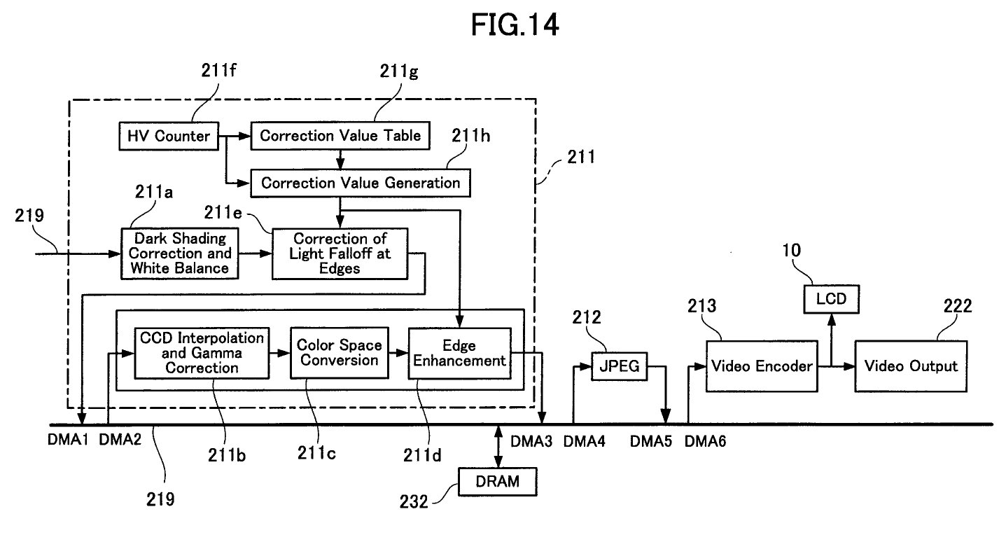

FIG. 15 is a diagram for explaining an image divided into a plurality of blocks by the conventional video processing apparatus.

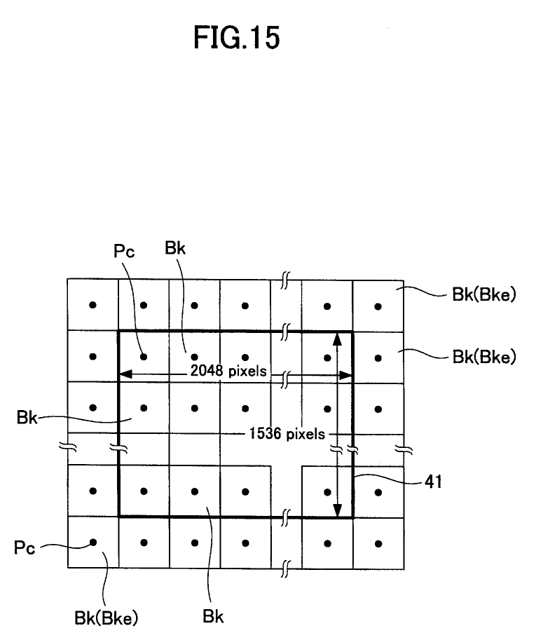

FIG. 16 is a diagram for explaining a correction value interpolation method of the conventional video processing apparatus.

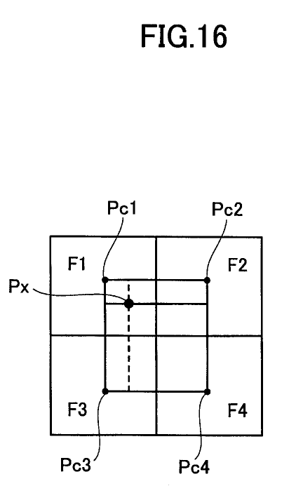

### EXPLANATION OF THE REFERENCE NUMERALS

1: lens unit
2: imaging element
3: analog preprocessing unit
4: A/D converter
5: shading correction circuit
5a: HV counter
5b: color filter selecting unit
5c: correction value storage unit
5d: correction gain interpolating unit
5e: dark shading correction unit
5f: peripheral shading correction unit
6: WB circuit
7: gamma correction circuit
8: Y/C processing circuit
50: correction value of block for dark shading
51: correction value of block for light falloff at edges of an image
211e: correction unit for light falloff at edges of an image
211g: storage unit for a table of correction value
211h: correction value producing unit
500: adder/subtracter
501: multiplier
502: bit shifter
503: adder

### DESCRIPTION OF THE PREFERRED EMBODIMENTS

The preferred embodiment of the video processing apparatus according to the present invention will be described hereinafter with reference to accompanying drawings.

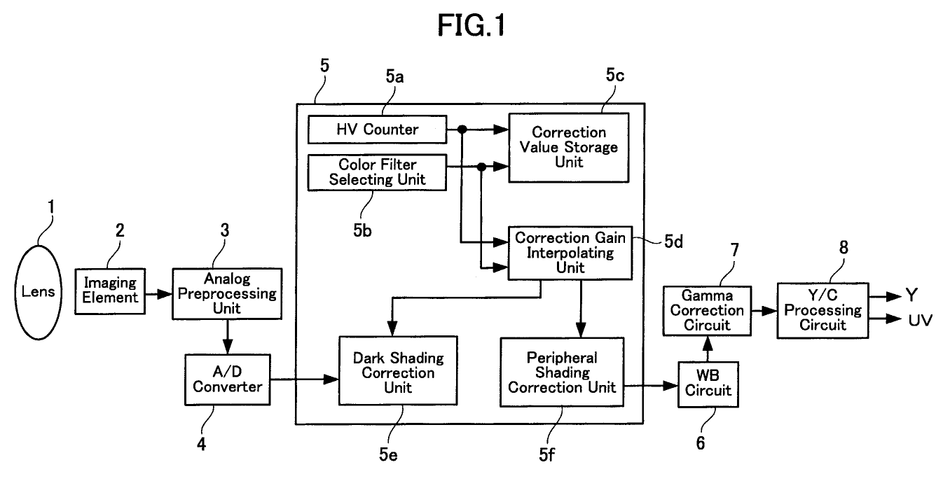

FIG. 1 is a block diagram showing the construction of the preferred embodiment of the video processing apparatus according to the present invention. As shown in FIG. 1, the video processing apparatus comprises a lens unit 1 for focusing light, and providing an image by adjusting focus, an imaging element 2 for converting the light focused by the lens unit 1 to an electric signal, an analog preprocessing unit 3 for performing noise reducing and gain adjusting operations to process the analog video signal from the imaging element 2, an analog-to-digital converter (hereinafter referred to as “A/D converter”) 4 for converting the analog video signal from the analog preprocessing unit 3 into a digital video signal, a shading correction circuit 5 for performing shading corrections to process the video signal from the A/D converter 4, a white balance circuit (WB circuit) 6 for adjusting a white balance of the video signal processed by the shading correction circuit 5, a gamma correction circuit 7 for performing a gamma correction of the video signal from the WB circuit 6, and a Y/C signal processing circuit 8 for performing luminance and color signal processing of the video signal from the gamma correction circuit 7.

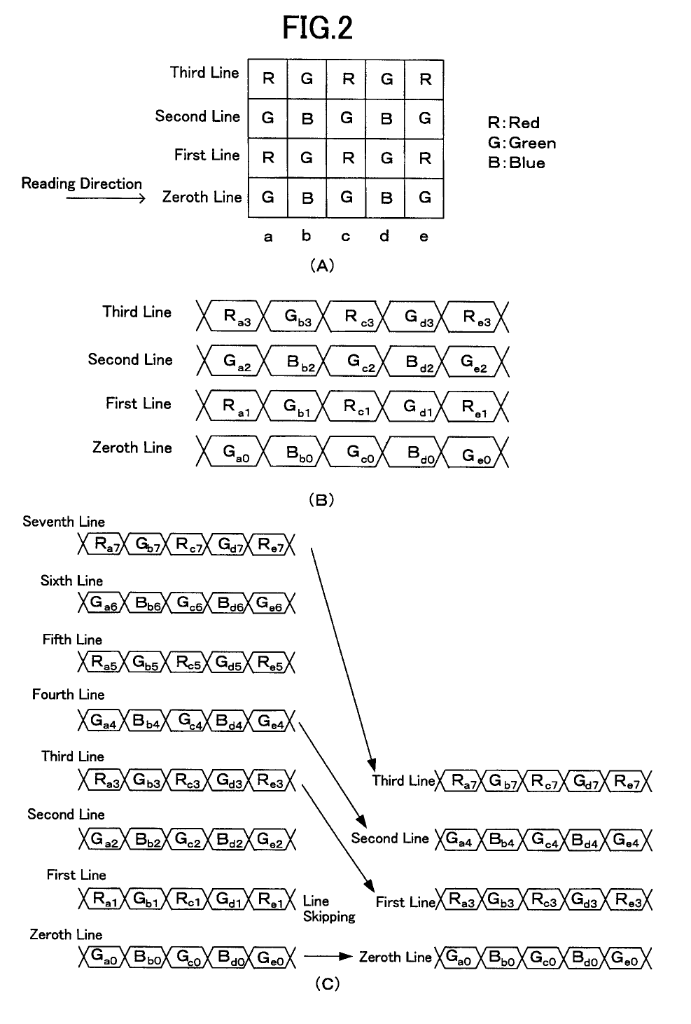

Here, the imaging element 2 has a plurality of color filters corresponding to pixels. The following description will be directed to the case that signals of pixels are outputted in a specific order from the imaging element 2. FIG. 2(A) is a diagram for explaining the color filters arranged in a matrix in a plane, the reference characters “R”, “G”, and “B” are respectively intended to indicate red, green, and blue filters. When the signals of all pixels are outputted from the imaging element 2 in a specific order, the imaging element 2 outputs a video signal constituted by data strings from pixels regularly repeated in order of green (G), blue (B), green (G), and blue (B), and data strings from pixels regularly repeated in order of red (R), green (G), red (R), and green (G).

The imaging element 2 may be adapted to output the signals of all pixels, or adapted to assume a pixel skipping mode to selectively output the signals of the pixels. When, for example, the imaging element 2 is in the pixel skipping mode, the imaging element may be adapted to output the signal of pixels every a few lines as shown in FIG. 2(C).

As shown in FIG. 1, the shading correction circuit 5 includes a HV counter 5a for outputting information on coordinates of pixel to be corrected, a color filter selecting unit 5b for selecting the type of the color filter of the designated pixel, a correction value storage unit 5c having stored therein correction values corresponding to blocks into which the image is divided, a correction gain interpolating unit 5d for calculating a correction gain of a designated pixel by performing an interpolation on the basis of correction values corresponding to blocks which are in the vicinity of the designated pixel, a dark shading correction unit 5e for performing a dark shading correction of the image on the basis of the correction gain calculated by the correction gain interpolating unit 5d, and a peripheral shading correction unit 5f for performing a peripheral shading correction for light falloff at edges of the image on the basis of the correction gain calculated by the correction gain interpolating unit 5d.

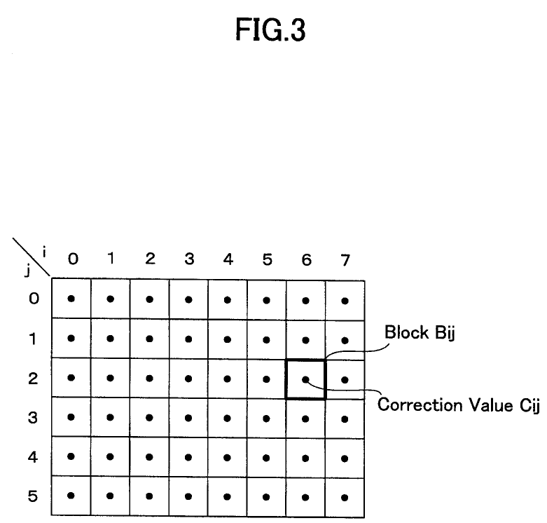

The operation of the video processing apparatus thus constructed as previously mentioned according to the embodiment of the present invention will be then described hereinafter with reference to the drawings. FIG. 3 is a block diagram for explaining an example of an image divided into blocks by the video processing apparatus according to the embodiment of the present invention.

As shown in FIG. 3, the image is firstly divided into, for example, 48 blocks arranged in an array of 6 rows and 8 columns in this embodiment. The correction value storage unit 5c has stored therein the correction values corresponding to the blocks of the image. More specifically, two correction values are needed for dark shading and light falloff at edges in each color. Therefore, the correction value storage unit 5c has 384 correction values stored therein under 48 blocks, four different color filters (R, Gr, B, and Gb), and two different corrections. As shown in FIG. 3, each of the blocks Bij has a center point, defined as a reference point, corresponding to a previously-measured correction value Cij which is stored in the correction value storage unit 5c.

The correction value storage unit 5c has communication means (not shown) for receiving latest correction values corresponding to the blocks from an external apparatus, and updating the previous correction values of blocks with the latest correction values of blocks. The correction values stored in the correction value storage unit 5c are updated by the communication means if necessary. The correction gain interpolating unit 5d judges whether or not the imaging element 2 is in the pixel skipping mode, and calculates a correction gain on the basis of the operation mode in which the imaging element 2 is.

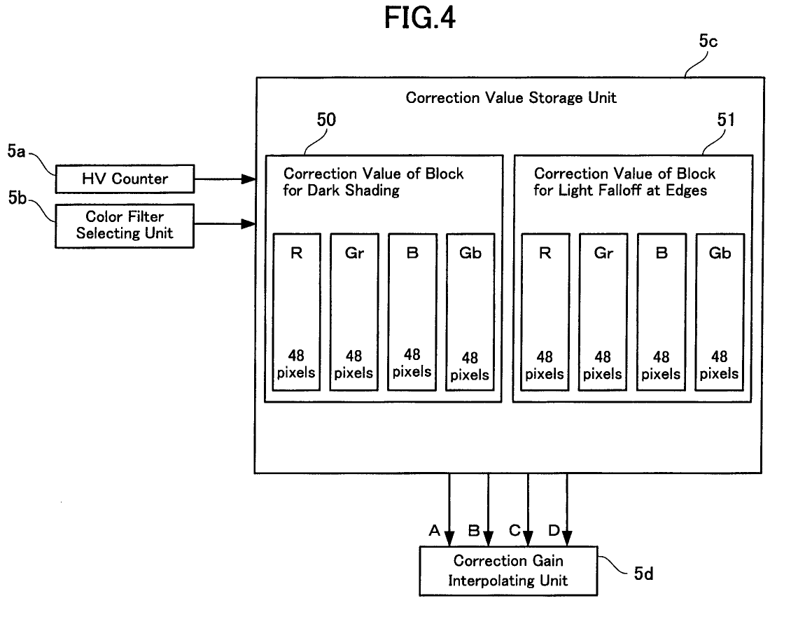

FIG. 4 is a diagram for explaining a process in which the video processing apparatus according to the embodiment of the present invention selects correction values from among the correction values corresponding to the respective blocks of the image. The correction values stored in the correction value storage unit 5c includes 48 correction values 50 corresponding to dark shading correction of an image in each color, and 48 correction values 51 corresponding to peripheral shading correction for light falloff at edges of the image in each color. The HV counter 5a indicates the current position by counting the number of the signals of the pixels from the A/D converter 4. The color filter selecting unit 5b selects one of color filters in response to the signals of pixels from A/D converter 4.

The correction value storage unit 5c decides four blocks which are in the vicinity of the pixel indicated by the HV counter 5a, selects four correction values corresponding to four blocks from among 384 correction values, selects correction values 50 corresponding to dark shading correction of an image, and 48 correction values 51 corresponding to peripheral shading correction for light falloff at edges of the image, and selects correction values on the basis of the type of the color filter selected by the color filter selecting unit 5b. The correction value storage unit 5c selectively outputs the correction values 50 corresponding to dark shading correction of an image, and 48 correction values 51 corresponding to peripheral shading correction for light falloff at edges of the image. Here, the correction value storage unit 5c selects and outputs four correction values A, B, C, and D of blocks adjacent to each other to the correction value interpolating unit 5d.

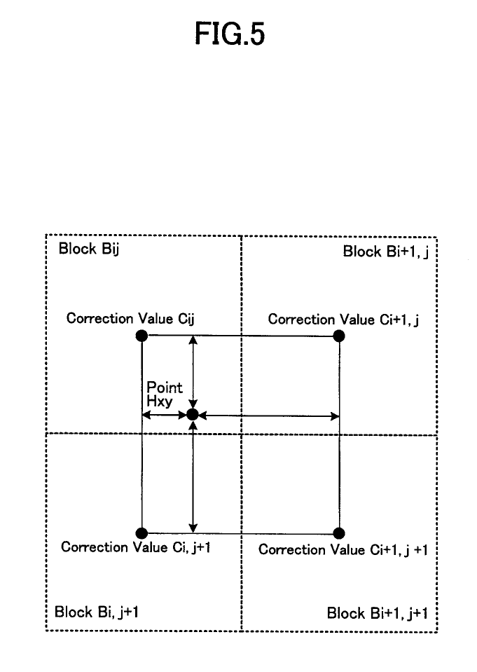

The following description will be then directed to the first and second interpolations to be performed with the correction values A, B, C, and D of the blocks by the correction gain interpolating unit 5d. FIG. 5 is a diagram for explaining the first interpolation to be performed on the basis of the selected correction values by the video processing apparatus according to the embodiment of the present invention. The correction gain interpolating unit 5d specifies four blocks including a block Bij in which the designated pixel is, and three blocks selected from among blocks which are on the left, right, top, bottom, upper left, upper light, lower left, and lower right as being closest to the designated pixel, and then calculates a correction gain Hxy of each pixel by performing the four-point linear interpolation on the basis of the correction values of the selected blocks.

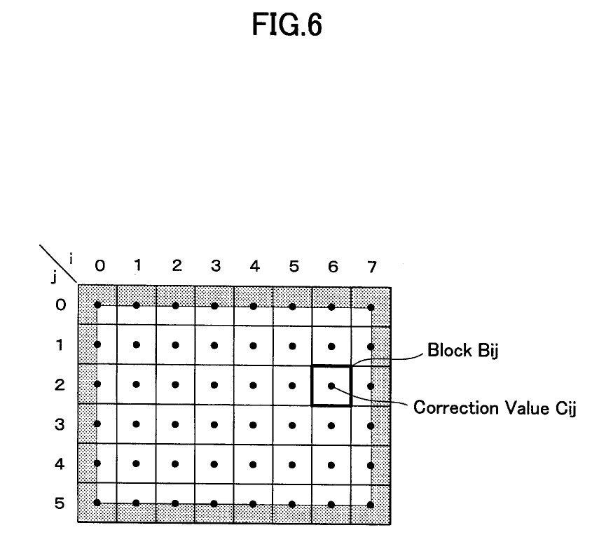

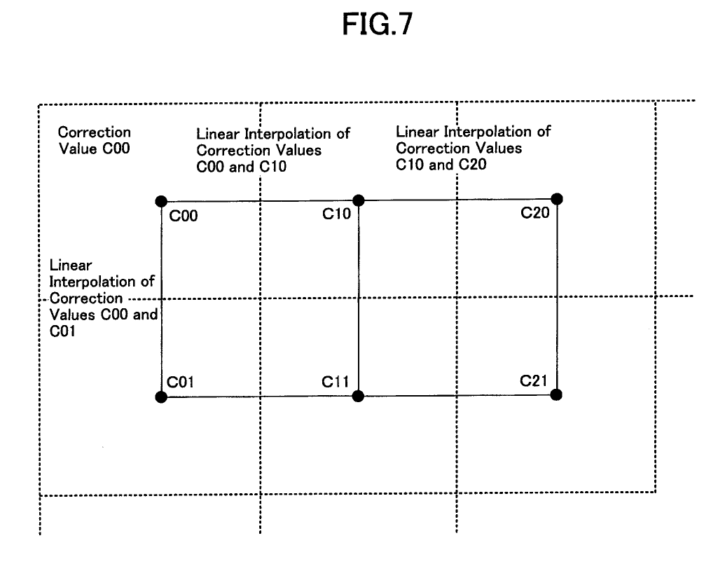

As shown in FIG. 6, the image has a peripheral portion in which the four-point linear interpolation cannot be performed. FIG. 7 is a diagram for explaining a first interpolation to be performed in a peripheral portion of an image by the video processing apparatus according to the embodiment of the present invention. As shown in FIG. 7, the correction gain interpolating unit 5d calculates a correction gain Hxy by performing two-point linear interpolation in the peripheral portion of the image, or uses a correction value of a block as a correction gain Hxy.

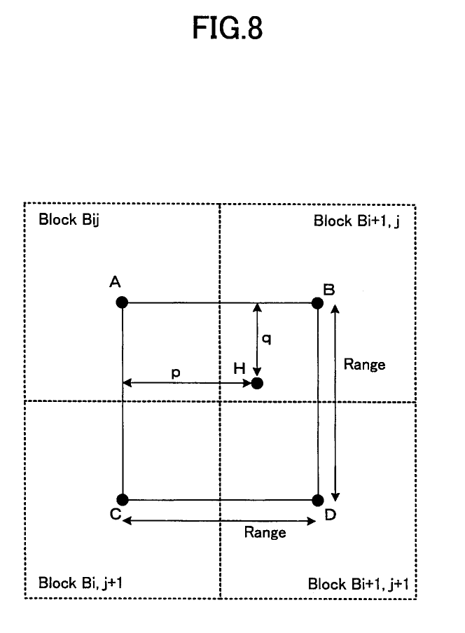

The conventional four-point linear interpolation method will be then described hereinafter with reference to FIG. 8. The blocks corresponding to the respective correction values A, B, C, and D have the shape of square, and equal sides of “Range” as shown in FIG. 8. The correction value corresponding to a given point H(p, q) is obtained from a following expression (1).

$$H = \frac{1}{Range} \{ ( 1 - \frac{p}{Range} ) * C + \frac{p}{Range} * D ) + ( 1 - \frac{q}{Range} ) \{ ( 1 - \frac{p}{Range} ) * A + \frac{p}{Range} * B \} \qquad ( 1 )$$

In general, the correction gains of the dark shading and peripheral shading corrections cannot be obtained at the same time without using two interpolation circuits corresponding to the dark shading and peripheral shading corrections.

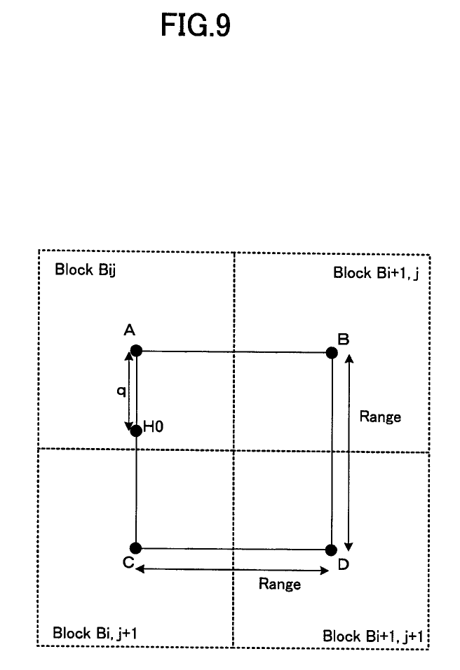

The following description will be then directed to a four-point linear interpolation method for allowing the video processing apparatus to perform a linear interpolation of the correction value by using a difference value. FIG. 9 is a diagram for explaining the four-point linear interpolation method for allowing the video processing apparatus to perform a linear interpolation of the correction value by using a difference value. The correction gain interpolating unit 5d calculates a correction value HO of a given point H0(0, q) on a line joining the center points A and C of two blocks by using a following expression (2).

$${H}_{0} = A + \frac{q}{Range} ( C - A ) \qquad ( 2 )$$

The correction gain interpolating unit 5d calculates the difference value HS of an interpolated correction value of a given point Hₚ(p, q) and an interpolated correction value of a point Hₚ₊₁(p+1, q) by using a following expression (3).

$$HS = \frac{q}{{Range}^{2}} \{ ( D - C ) - ( B - A ) \} + \frac{1}{range} ( B - A ) \qquad ( 3 )$$

The correction gain interpolating unit 5d calculates the correction gain of the given point Hₚ(p, q) by using the interpolated correction value HS calculated from a following expression (4).

$${H}_{p} = {\sum }_{t = 1}^{p} {H}_{t - 1} + HS \qquad ( 4 )$$

The dark shading and peripheral correction units share a circuit for performing interpolations by using the expressions (2) and (3) by reason that the correction value HO and the difference HS are calculated in each line of an area defined by corrections values A, B, C, and D of blocks. Further, an interpolating unit for performing a four-point linear interpolation by using the expressions (2), (3), and (4) is simple in construction in comparison with an interpolating unit for performing a four-point linear interpolation by using the expression (1) by reason that the number of multiplier and divider of the former is smaller than that of the latter. The video processing apparatus according to the present invention is improved in circuit size in comparison with the conventional video processing apparatus.

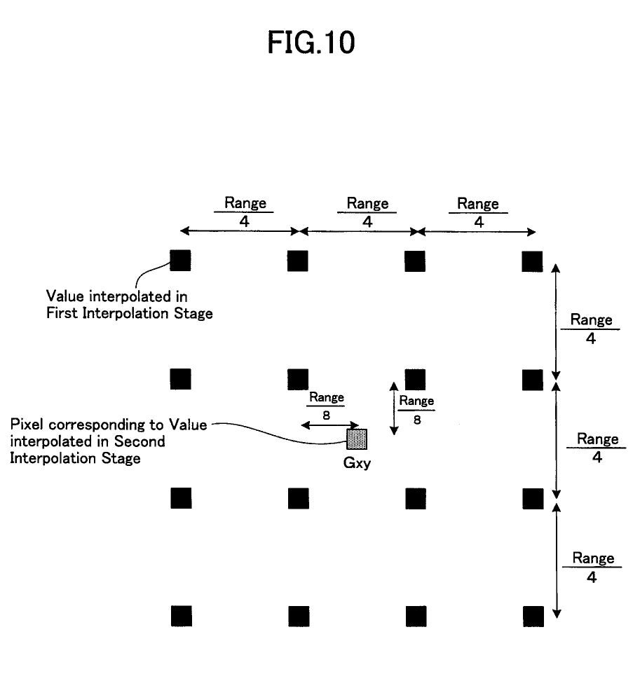

Then, the correction gain interpolating unit 5d performs the second interpolation by using the correction value H calculated in the first interpolation stage. FIG. 10 is a diagram for explaining the second interpolation method of allowing the video processing apparatus to perform the second interpolation by using the correction value H calculated in the first interpolation stage. As shown in FIG. 10, the correction gain interpolating unit 5d selects, in response to a given point (x, y), 16 correction values from among the correction values Hp interpolated in the first interpolation stage, and calculates mean value of 16 correction values as a correction gain Gxy. Finally, the correction gain interpolating unit 5d decides a correction gain Gxy corresponding to each pixel (x, y) in the second interpolation stage.

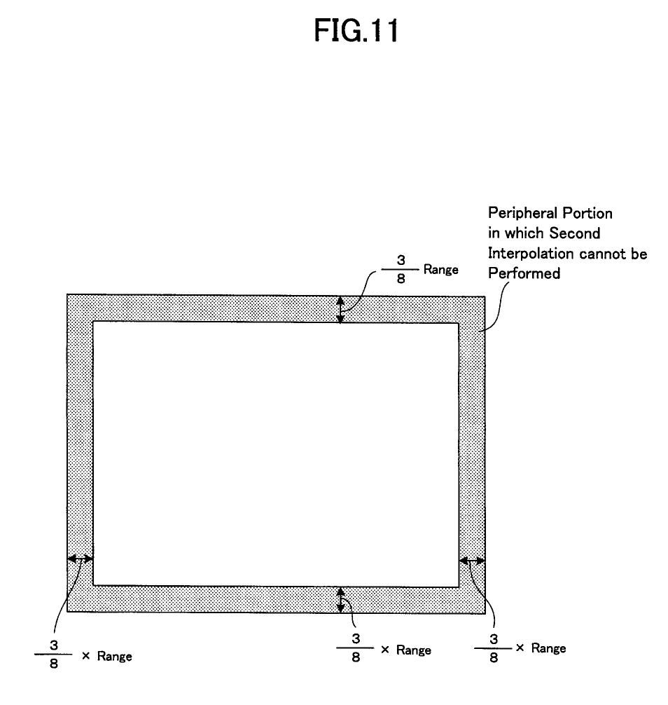

Although the image has a peripheral portion in which the interpolation cannot be performed in the second interpolation stage as shown in FIG. 11, the correction gain interpolating unit 5d decides the correction gain Hxy obtained in the first interpolation stage as the correction gain Gxy.

When the imaging element 2 is in a pixel skipping mode, the correction gain interpolating unit 5d calculates the correction gains of pixels from the correction values of blocks by performing the interpolations on the basis of the pixel skipping mode of the imaging element 2. On the other hand, the correction gain interpolating unit 5d calculates the correction gains of pixels from the correction values of blocks on the basis of the size of the image produced by the imaging element 2.

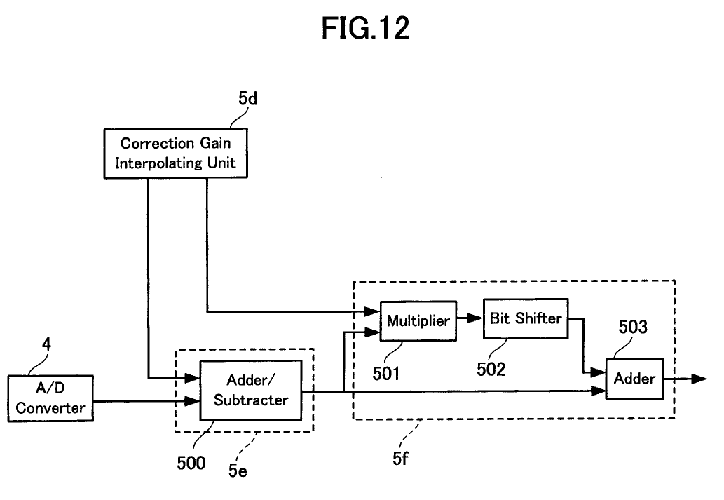

FIG. 12 is a block diagram for explaining the shading corrections to be performed on the basis of the correction gain. The correction gain for the dark shading of the image calculated by the correction gain interpolating unit 5d is used in the dark shading correction process of the dark shading correction unit 5e, while the correction gain for light falloff at edges of the image calculated by the correction gain interpolating unit 5d is used in the peripheral shading correction process of the peripheral shading correction unit 5f. The dark shading correction unit 5e includes an adder/subtracter 500, while the peripheral shading correction unit 5f includes a multiplier 501, a bit shifter 502, and an adder 503.

Firstly, the adder/subtracter 500 performs the dark shading correction by adding (or subtracting) the correction gain for the dark shading of the image calculated by the correction gain interpolating unit 5d to the relevant pixel data from the A/D converter 4.

Then, the multiplier 501 multiples the pixel data corrected by the dark shading correction unit 5e with the correction gain for light falloff at edges of the image calculated by the peripheral shading correction unit 5f. The bit shifter 502 performs bit shift of the pixel data from the multiplier 501. The adder 503 performs the peripheral shading correction by adding the pixel data corrected by the dark shading correction unit 5e to the pixel data shifted by the bit shifter 502.

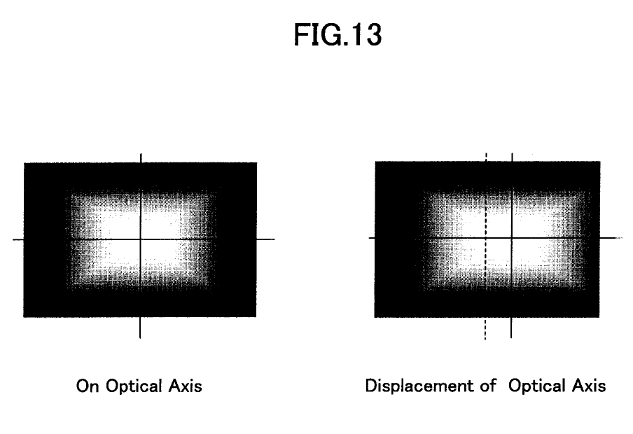

The following description will be then directed to a displacement of the imaging element to an optical axis. Even if the imaging element has a center axis axially aligned with the optical axis as shown in FIG. 13, the video processing apparatus can perform dark shading and peripheral shading corrections, without being affected by the displacement of the imaging element to an optical axis. For example, the correction gain interpolating unit 5d adjusts an area to which the correction values C of blocks are applied, without changing the position of each block.

From the foregoing description, it will be understood that the video processing apparatus according to the embodiment of the present invention can reduce the amount of correction values to be stored in the correction value storage unit by reason that the correction values correspond to respective blocks of an image, an correction gain of each pixel is calculated from the correction values of blocks through interpolation steps, and can perform separately two shading corrections by comprising two correction units for dark shading of image and light falloff at edges of image.

The video processing apparatus according to the embodiment of the present invention can calculate, with accuracy, correction gains of pixels from the correction values of blocks by reason that the interpolated correction values are firstly calculated from the correction values of blocks through the four-point linear interpolation in the first stage, the correction gains of pixels are then calculated from the interpolated correction values through the second interpolation in the second stage.

The video processing apparatus according to the embodiment of the present invention can be improved in construction, without comprising two different interpolating units for dark shading of image and light falloff at edges of image, by reason that the correction gain interpolating unit is adapted to calculate correction gains corresponding to the correction for dark shading of image and correction gains corresponding to the correction for light falloff at edges of image. The dark shading and peripheral correction units share the correction gain interpolating unit.

In this embodiment, the video processing apparatus performs the dark shading and peripheral shading corrections of the image divided into 48 blocks on the basis of correction values corresponding to 48 blocks. Needless to say, the present invention is not limited to the number of blocks. The imaging element 2 has four different color filters, however, the present invention is not limited to the type of color filter.

### INDUSTRIAL APPLICABILITY OF THE PRESENT INVENTION

As will be seen from the foregoing description, the video processing apparatus can perform separately two shading corrections including a dark shading correction of an image and a peripheral shading correction for light falloff at edges of the image, and can calculate, with accuracy, correction gains of pixels from the correction values of blocks by performing two interpolations, and perform two or more shading corrections without being increased in circuit size.

1. A video processing apparatus, comprising:
an imaging element for producing an image of an object;
a correction value storage unit having stored therein correction values of blocks each of which forms part of said image produced by said imaging element;
a correction gain interpolating unit for calculating a correction gain of a designated pixel of said imaging element by performing an interpolation on the basis of correction values corresponding to blocks which are in the vicinity of said designated pixel;
a dark shading correction unit for performing a dark shading correction of said image on the basis of said correction gain calculated by said correction gain interpolating unit; and
a peripheral shading correction unit for performing a peripheral shading correction for light falloff at edges of said image on the basis of said correction gain calculated by said correction gain interpolating unit.

2. A video processing apparatus as set forth in claim 1, in which said correction gain interpolating means has a first correction gain calculating function of calculating a first correction gain by performing four-point linear interpolation on the basis of four correction values including a correction value corresponding to a block including said designated pixel, and correction values corresponding to blocks which are in the vicinity of said block including said designated pixel, and a second correction gain calculating function of calculating a second correction gain by performing a second interpolation on the basis of said first correction gain.

3. A video processing apparatus as set forth in claim 1, in which said correction values of said blocks stored in said correction value storage unit includes correction values for said dark shading correction and correction values for said peripheral shading correction.

4. A video processing apparatus as set forth in claim 1, in which said correction values of said blocks stored in said correction value storage unit includes correction values for said dark shading correction, and corresponding to said blocks of said image, and correction values for said peripheral shading correction.

5. A video processing apparatus as set forth in claim 1, in which said imaging element has a plurality of color filters regularly arranged in a specific order, and corresponding to said respective pixels.

6. A video processing apparatus as set forth in claim 5, in which said correction value storage unit has correction values corresponding to primary colors of said color filters, and corresponding to said blocks.

7. A video processing apparatus as set forth in claim 6, in which said correction gain interpolating unit is adapted to calculate a correction gain on the basis of said correction values corresponding to primary colors of said color filters.

8. A video processing apparatus as set forth in claim 1, in which said dark shading and peripheral shading correction units are adapted to perform a color shading correction of said image on the basis of said correction values corresponding to primary colors of said color filters.

9. A video processing apparatus as set forth in claim 1, in which said correction value storage unit has communication means for receiving latest correction values corresponding to said blocks from an external apparatus, and updating said previous correction values of said blocks with said latest correction values of said blocks.

10. A video processing apparatus as set forth in claim 1, in which said correction gain interpolating unit is adapted to adjust in size said blocks on the basis of the size of said image to calculate correction values corresponding to said adjusted blocks, and to calculate a correction gain on the basis of correction values corresponding to said blocks adjusted in size.

11. A video processing apparatus as set forth in claim 1, in which said correction gain interpolating unit is adapted to calculate a correction gain by performing an interpolation on the basis of an interpolation method corresponding to arbitrarily defined blocks.

12. A video processing apparatus as set forth in claim 1, in which said correction gain interpolating unit is adapted to calculate a correction value of a block which is not stored in said correction value storage unit, on the basis of said correction values of blocks adjacent to said block corresponding to which is not stored in said correction value storage unit.

13. A video processing apparatus as set forth in claim 1, in which said correction gain interpolating unit is adapted to calculate a correction gain by performing an interpolation on the basis of said pixel skipping of said imaging element.

14. A video processing apparatus as set forth in claim 1, in which said correction gain interpolating unit is adapted to adjust coordinates of each pixel of said imaging element by performing a displacement correction on the basis of a displacement of said imaging element to an optical axis, and to calculate an interpolated correction value from said correction values stored in said correction value storage unit by performing said interpolation on the basis of said adjusted coordinates of each pixel of said imaging element.

15. A video processing apparatus as set forth in claim 2, in which said correction gain interpolating unit is adapted to calculate, by using said correction values stored in said correction gain storing unit, the difference between correction gains of first and second pixels adjacent to each other in a horizontal line of a square defined by four center points of blocks adjacent to each other, and to calculate a correction gain of each pixel of said horizontal line from said calculated difference between said correction gains of said first and second pixels.

16. A video processing apparatus as set forth in claim 2, in which said correction gain interpolating unit is adapted to calculate said second correction gain on the basis of said first correction gains of said pixels adjacent to said designated pixel.

17. A video processing apparatus as set forth in claim 2, in which said correction gain interpolating unit is adapted to perform said dark shading correction of said image and said peripheral shading correction for light falloff at edges of said image on the basis of said second correction gain.
